(19) United States
(12) Patent Application Publication
(10) Pub. No.: US 2006/0229947 A1
(43) Pub. Date: Oct. 12, 2006

(54) Methods and systems for transacting targeted discounts

(76) Inventor: Michael T. Rossides, Scottsdale, AZ (US)

Correspondence Address: MICHAEL ROSSIDES, 11167 E. MIRASOL CIRCLE, SCOTTSDALE, AZ, 85255, US

(21) Appl. No.: 11/450,512

(22) Filed: Jun. 10, 2006

(30) Foreign Application Priority Data
Dec. 13, 2004 (WO) PCT/US04/42019

(51) Int. Cl. G06Q 30/00

(52) U.S. Cl. 705/14

(57) ABSTRACT

The invention is a method for operating a computer database system to enable a seller to offer and transact targeted discounts. A first module enables a seller to enter a targeted discount offer including: a product or service that a discount applies to, a discount amount, and targeting conditions for receiving that discount. A second module enables a buyer to accept the discount. A third module executes a payment bet in which the expected value is set at the discount amount. A fourth module enables a buyer to learn that she has provisionally won a payoff in the bet. A fifth module enables a buyer to claim she is eligible for the payoff. A sixth module enables inspection to determine if the buyer meets the conditions of the discount offer. A seventh module enables the winning, eligible buyer to be paid the payoff.

### CROSS-REFERENCES TO RELATED APPLICATIONS

This application claims priority of U.S. provisional patent application 60/529,071 filed on Nov. 12, 2003.

This application also claims priority of U.S. utility application Ser. No. 10/811,643 filed on 29/03/2004 and incorporated here by reference.

This specification is a virtual copy of PCT application PCT US2004/042019 and this application is the US national phase application of that PCT application.

### STATEMENT REGARDING FEDERALLY FUNDED RESEARCH

Not applicable.

### BACKGROUND

1. Field of the Invention

The invention relates to methods for implementing discounts.

2. Description of Related Art

Sellers often tailor discounts to a specified group of people. An example is “affiliate marketing” where, say, an insurance company gives members of a particular association a special deal. Another example is senior discounts.

As a condition of providing a targeted discount, a seller usually requires that the person receiving the discount show that she is a member of the specified group. For example, a person might have to show her AAA card in order to receive a discount on a hotel room.

We disclose methods and systems for enabling sellers to transact targeted discounts more easily and with lower costs. By lowering the transaction costs of targeted discounting, the methods and systems disclosed enable sellers to use more price discrimination.

A key difference between the inventive discounting method disclosed and previous methods is the use of the expected value payment method, U.S. Pat. No. 5,269,521.

The author previously noted in PCT application US00/18715 that the EVPM can be used to transact coupon/rebate payments that apply to all buyers. A coupon/rebate that applies to all buyers is not a tool for price discrimination.

But the author did not previously disclose how the EVPM could be integrated into a method and system for providing discounts to specified groups, thereby creating a new tool for price discrimination.

For example, the methods disclosed here make it practical, for the first time, for a broad range of sellers to make discounts available to people according to income or net worth.

Thus, an aspect of the invention is to provide a general method for enabling sellers to charge according to people's ability to pay, which has long been a vague ideal in economics. This vague notion makes sense for many products and services, especially those where margins are high and a seller can afford to charge less to increase sales or for the sake of equity. For example, a producer of an e-book might be willing to charge relatively affluent consumers $20 for the book, while charging relatively poor students $4. A $4 sale is better than no sale at all.

Student discounts are a well-known attempt to charge people according to their ability to pay. A similar notion is the idea of “means tested” prices, as with food stamps and other programs that attempt to implement price discrimination according to ability to pay.

But these and most price discrimination methods are crude and non-universal. Not all students are poor, for instance, and therefore, not all require discounts. Means-testing usually requires substantial documentation of a buyer's wealth, which translates into high-transaction costs, at minimum, and an unwillingness to reveal one's wealth in many cases. Who, for instance, would provide tax returns to a seller in order to receive, say, a $5 discount on a book?

The inventive method provides a solution to the problem of means tested pricing, enabling a seller to more easily charge according to a person's financial condition.

### BRIEF SUMMARY OF THE INVENTION

The invention is a method for operating a computer database system for the purpose of enabling a seller to offer and transact discounts targeted to people according to criteria that the seller specifies. The method can be divided into a set of modules. A first module enables a seller to enter a targeted discount offer including: a product or service that a discount applies to, a discount amount (a constant amount or a percentage of a purchase), and a set of targeting conditions for receiving that discount. A second module enables a buyer to claim (accept) the targeted discount. A third module executes an expected value payment bet in which the expected value is set at the discount amount. A fourth module enables a buyer to learn that she has provisionally won a payoff in the bet corresponding to the discount she claimed. A fifth module enables a buyer to claim that she is eligible for the payoff that corresponds to the discount. A sixth module enables inspection of the buyer to determine if she meets the membership conditions of the discount offer. A seventh module enables the winning, eligible buyer who has passed the inspection to be paid the payoff.

Modules can be added to make it easy to tailor and transact discounts in which the key targeting condition is that the buyer has a net income and/or net worth within a range specified by the seller. Processes can also be added to prevent cheating.

Modules can be added to make it easy to tailor and transact discounts in which the key targeting condition is that the buyer is buying from the seller for the first time.

Modules can be added to make it easy to tailor and transact discounts in which the key targeting condition is that the buyer has performed at a certain academic level.

### BRIEF DESCRIPTION OF THE DRAWINGS

There are no drawings.

### DETAILED DESCRIPTION OF THE INVENTION

### Contents

Initial Definitions

How this Specification Is Written

Part 1: Core modules comprising the core inventive method and system.

Part 2: Embodiments in which the buyer claims an EV Targeted Discount by matching a number associated with his proof-of-purchase against a public random number.

Part 3: Embodiments in which the buyer claims an EV Targeted Discount by communicating with a Targeted Discount Transaction System.

Part 4: Embodiments in which the seller submits the buyer's EV Targeted Discount claim to the Targeted Discount Transaction System.

Part 5: Embodiments in which a condition for receiving a Targeted Discount is a means test.

Part 6: Embodiments in which a condition for receiving a Targeted Discount is that the buyer is buying from the seller for the first time.

Part 7: Embodiments in which a condition for receiving a Targeted Discount is that the buyer or buyer's child has performed at a specified level in school.

Part 8: Methods for Transferring Payment from Sellers to Qualified Buyers

How this Specification Is Written

This specification is organized as a set of descriptions of modules—sub-processes—that together comprise the inventive method.

The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing entities that communicate with each other.

The goal of this specification is to disclose the key novel elements and steps of the inventive method and system. There is no ideal way to present these elements and steps, therefore, those skilled in technical writing or programming will see better ways to organize and present this disclosure.

### ILLUSTRATIVE EXAMPLES

Example cases are provided. Those skilled in the art will know that these examples are illustrative only and do not limit the range of applications of the present invention.

Standardized Options

Many of the options described in this specification, such as the ability to set the payoff of EV payment bets, may be standard in practice. Those skilled in the art will readily see where an option may be converted into a default such that the user must use the default.

Implementing the Invention so it can be Used by Multiple Sellers

The invention can be implemented to be used by a single seller. It can also be implemented as an online database system that is used by multiple sellers. This multiple seller application is the more important one, so we assume in this specification that the invention is implemented in this way.

Targeted Discounts Offered to Organizations

It is also readily possible to adapt the invention so that sellers can offer targeted discounts to organizations. For instance, a publisher might want to offer discounts to poor organizations in, say, Ghana. The invention's process for registering a buyer claiming a discount can include steps for registering an organization and registering an individual acting as a purchasing representative for that organization. For simplicity, we assume that recipients of targeted discounts are individuals.

Initial Definitions

We define several terms here and then add definitions as necessary.

Product. The term product will represent any product or service.

Targeted Discount (TD). A discount that is offered only to a person who fits specified target conditions.

Targeting Conditions. The conditions that define who is eligible for a TD.

EV Targeted Discount (EV TD). A targeted discount paid as an expected value via a bet.

EV TD bet. An EV payment bet in which the EV=TD. Also called a TD bet.

Targeted Discount Method (TDM). The inventive method for transacting an EV TD.

Targeted Discount Transaction System (TDTS). The inventive computer database system operated according to the TDM, a database system for transacting EV TD's.

Discount Amount (DA). The amount of a discount, which can be a constant amount or a percentage of a sale amount.

Seller. A company (or other entity or agency) that offers an EV TD. Also called the offeror.

The seller can be represented by a person.

Buyer. An individual (or organization) who buys a product that has an associated TD. A buyer may also be called a recipient of a TD. A buyer will also be referred to as Ben.

Inspector. A system-authorized user who (1) decides whether a buyer is eligible to receive a TD and (2) provides the inspection decision to the system. TD claim. A claim by a buyer that he is owed an EV TD, including an action by the buyer, or by a seller on the buyer's behalf, to reveal the result of his EV TD bet.

Payoff claim. A claim by a buyer that he is owed the payoff from an EV TD bet.

### Part 1

### Core Modules of the Invention

1.1 Module for Enabling a Seller to Enter a Targeted Discount Offer

1.2 Enabling a Buyer to Find a Targeted Discount Offer

1.3 Enabling a Buyer to Claim a Targeted Discount

1.4 Executing Payment Bet in which EV Equals Discount Amount

1.5 Enabling a Buyer to Learn that He Has Provisionally Won a Payoff

1.6 Enabling a Buyer to Claim a Payoff

1.7 Enabling an Inspector to Verify that a Buyer Meets the Offer Conditions

1.8 Enabling a Winning, Eligible Buyer to Be Paid the Payoff

1.9 Enabling Reports that Show Sellers the Responses to a TD Offer

### 1.1 Module for Enabling a Seller to Enter a Targeted Discount Offer

A first module of the inventive method is a process for enabling a seller to enter a TD offer into a database system—the TDTS—that enables the transaction of the offer.

As part of this module (or as a separate module) the invention will include a process for establishing a seller account for authenticating a seller so that the seller can then enter and modify TD offers. A seller account process can include sub-processes for establishing a deposit or credit account for transferring discounts to buyers as well. We do not elaborate on seller account processes because they are well known.

Upon establishing a seller account, the seller will be able to create and store a TD offer.

Accordingly, the invention also provides a method of (or system for) entering into the TDTS a TD offer comprised of a set of data that includes:
The seller name (company or other entity) making the TD offer.
The description of the product(s) or seller that the TD offer applies to (rather than specify a single product, a seller can specify a set of products, or further, can specify all the products that the seller sells, in which case the seller may only need to specify the seller's name. The description can specify a location for the purchase(s). It can specify an amount of money to be spent by the buyer.
The discount amount that is a constant amount or that is a percentage of the money spent on the product that the TD offer applies to.
The expiration date of the TD offer.
The targeting conditions defining who is eligible to receive the TD.
The expected value (EV) bet terms that define the EV bet used to pay the TD.
The date/time the TD bet result is to be revealed (when the buyer can find out the result, that is).
The kind of evidence that is required to verify that a buyer meets the targeting conditions (unless it is left to an inspector to decide what evidence is needed).

As noted, many of the terms above can be standard. The TDTS stores the offer data and timestamps it. The offer may be identified with additional data, including an offer name or other offer ID. This module can also include steps for enable a seller to change the offer, and for directing the TDTS to keep a record of the previously entered offer.

Illustration

Let us assume that Starbucks Coffee wants to offer a discount of 10% to people whose income is less than $15,000 per year. Starbucks establishes an account and then enters:
Seller: Starbucks
Product discount applies to: All Starbucks drinks
Discount amount: 10%
Expiration: May 10, 2004
Targeting Conditions: Income <=$15,000
Bet terms: A buyer will have a 0.001 probability of winning 1,000× the discount amount (DA)
When bet result is revealed: 60 days after purchase
Evidence required: Tax return

### 1.2 Enabling a Buyer to Find a Targeted Discount Offer

The invention can provide a module for enabling a prospect to find the TD, but this module is not necessary in many embodiments. A TD offer is like a coupon offer, and as such, it can be made available in many ways. An invention for creating and redeeming the coupon does not necessarily have to include a module for enabling the coupon to be found, because the coupon can be presented in a variety of ways outside the invention, as in a newspaper ad or at a store. Likewise, the present invention for creating and transacting TD offers can process TD offers that are presented outside the invention.

Depending on the implementation, a buyer does not have to find a TD offer in a TD offer database system. The offer can be presented to the buyer for claiming via a variety of front-ends, the database aspect of the invention being hidden from the buyer. We also note that the inventive method and system can also present audio interfaces to buyers.

It is also possible to make the finding of an offer an integral part of the invention. Accordingly, the invention can provide a method of (or system for) enabling a user to find a TD offer along with a description of the product that the offer applies to, and further, for enabling a user to initiate a claim for the TD by pressing a button or the equivalent that corresponds to the TD.

The inventive method can also be implemented as directory system for creating, finding and redeeming TD offers. Such a directory would enable a buyer to search by any of a variety of criteria used by a seller to describe/define the seller's TD offer. Central to an offer are the eligibility conditions, and so, a directory can also enable a buyer to search for an offer using eligibility conditions as search criteria. Accordingly, the invention can provide a method of (or system for) enabling a user to find a TD offer using search criteria, such as a product name, seller name, eligibility conditions, and other identifying characteristics of an offer, and further, for enabling a user to initiate a claim for the TD offer by selecting an offer presented in the directory.

### 1.3 Enabling a Buyer to Claim a Targeted Discount

The invention will also provide a module for enabling a buyer to claim an EV TD.

This kind of claiming is different than claiming the payoff from a TD bet. We can think of claiming an EV TD as accepting the chance to win an EV payment bet where the EV equals the TD. Thus, claiming an EV TD is analogous to accepting/claiming a lottery ticket whose result has not been revealed.

To claim a TD, a user, or a seller on the user's behalf, takes an action to, at least, reveal the result of the user's TD bet. Accordingly, the invention provides a method of (or system for) enabling a user to claim an EV TD by, at least, enabling the user to find out the result of the payment bet that corresponds to the TD offer.

Accordingly, the invention provides a method of (or system for):
enabling the user to request the TD bet result, or
providing a public random number that is used to decide the bet, or
using an externally generated and published random number to decide the bet, said number being internally represented in the inventive system to correspond with the user's TD bet.

Depending on the embodiment, the user, or a seller acting on the user's behalf, may also be required to enter a set of claim data in order to complete the EV TD claiming process. This claim data will vary depending on the embodiment and particular implementation.

In Parts 2, 3, and 4, we describe three different types of embodiments that correspond to three significantly different ways that the invention can enable a user to claim an EV TD.

The differences in the claim processes can lead to additional differences in how a buyer (an EV TD claimant) is authenticated, how the EV payment bet is executed, and/or, how a buyer finds out if he has won the TD payment bet.

Making the Claim Identifiable to Prevent Double-Claiming

A claim should be made identifiable in such a way that a user cannot double-claim a TD. There are many ways for achieving this object, which we discuss in Parts 2, 3 and 4.

Enabling a User to State how he Fits the Conditions of the TD Offer

In certain kinds of TD offers the TD amount will vary according to the qualifications of the buyer. For example, a TD offer may be a $10 EV discount for people whose income is <=$10,000, and a $5 EV discount for people whose income is between $10,000 and $20,000. So, depending on the embodiment, and upon the conditions of the TD offer, the invention can enable a buyer, prior to learning the result of the TD bet, to enter the how he fits the conditions of the TD offer.

Accordingly, the invention can further provide a method of (or system for) modifying the execution of the TD bet according to a buyer's statement of eligibility.

The inventive method can also employ a two-bet method in which a buyer enters a statement of eligibility after winning a first payment bet. The terms of the second bet can then be set according to the statement of eligibility that the buyer enters.

We note that in many embodiments and implementations, a buyer's statement of eligibility may not be necessary at all until the buyer attempts to claim the payoff.

Maintaining a User's Claiming History

In order to prevent cheating, it may be useful to store all of a user's claim attempts. A user who makes claims at a statistically significant rate above average may be indicating that he is a cheater. Thus, as part of the process for enabling a user to claim an EV TD, the invention can provide a method of (or system for) storing a claim as part of a user's claim history, which can be made accessible to system operators.

The invention can also provide for an additional class of user, cheat detection inspector or cheat detection expert, who is authorized by the system to review the claim histories of users to detect cheating.

The invention can also provide for displaying a buyer's TD claim history, or statistics summarizing the claim history, to the buyer himself.

### 1.4 Executing Payment Bet in which EV Equal Discount Amount

The invention will provide a module for executing the TD bet.

For simplicity, we assume that the EV of the bet is equal to the TD amount, while we realize that the EV bet terms can include an adjustment such that the EV is less than the TD amount in order to accommodate a TD transaction fee.

We do not have anything to add to the art of deciding EV payment bets. Let us just point out that the invention provides a method of (or system for):
registering a user's EV payment bet for a TD and internally generating/supplying a random number in the range required by the user's TD bet, and storing the result of that bet, and/or
supplying a public random number, associated in some way with a user's TD bet, for instance by meta-rules of the invention, to be used to decide the bet (this public number can apply to more than one user's TD bet), and/or
using an externally generated and published random number to decide the TD bet, said number being stored internally and corresponding in some way with the user's TD bet (this public number can apply to more than one user's TD bet).

As discussed previously, the TD can be a percentage, such as, 10%. In this case, the payoff in the EV bet will be a multiple of the percentage, with the probability of winning set at 1/multiple. Or, the discount can be a static amount, such as, $5 with the probability of a buyer winning set at (static amount)/(payoff).

Using a Two-or-More-Stage Betting Process for EV Payment

Rather than a single EV payment bet, the TD bet process can use two separate bets (or can use a series of “parlay” bets) in which the second bet is a parlay bet where the EV for the series of two or more bets equals the TD.

One reason for employing more than one bet is that the winning results and the associated winning buyers can be recorded, which may enable the system to flag buyers who are cheating. A second reason parlay bets may be used is that an initial bet payoff may not be enough to justify doing an inspection, but may justify inducing a buyer to supply payoff claim information, especially purchase amount information, which can be used in second bet with a higher payoff. A third reason parlay bets may be useful is that they may enable a seller to take payoff risk in a first bet, but not in a second bet (see Section 1.8), which may be desirable to a significant percentage of sellers.

Accordingly, the invention can provide a method or (of system for):

executing a first EV payment bet corresponding to a buyer's purchase, such that the EV<TD amount offered by a seller, this first bet having a first payoff,

if the buyer wins the bet, requesting that the buyer enter a set of payoff claim data,

if no claim data is submitted, canceling the TD for the buyer,
if the buyer submits the payoff claim data,
   registering the payoff claim data for possible later use in an inspection of the buyer, storing the claim data in the buyer's user profile, and, possibly using the purchase amount to set the terms of the second payment bet, and
   executing a second EV payment bet where the probability of the buyer winning equals (first payoff)/(higher payoff) and the EV equals the TD amount offered by the seller.

### 1.5 Enabling a Buyer to Learn that He Has Provisionally Won a Payoff

The invention will provide a way for a buyer who has claimed an EV TD to find out if he has won the TD bet, that is, if he has provisionally won the payoff. We say provisionally because, in order to collect the payoff, the buyer will still have to prove that he meets the conditions of the TD offer.

In certain embodiments, there does not have to be an explicit communication process contained within the invention for informing a buyer of the bet result. A buyer can check a public source that publishes the random numbers that decide the TD bets, just as lottery players can check a public source that publishes the “winning” number for a lottery.

Accordingly, the invention may or may not provide a method of (or system for) informing a buyer that he has provisionally won a payoff.

As discussed in Section 1.3, there are many methods by which the invention can enable a user to find out if he has won the TD bet. The method used depends on the embodiment and particular implementation. We describe some of these methods in Parts 2, 3, and 4.

### 1.6 Enabling a Buyer to Claim a Payoff

The invention will provide a module for enabling a winning buyer to claim that he is eligible for the payoff from the TD bet he has won.

Once a buyer learns he has won a TD bet, he will need to claim his payoff, if he has met the conditions of the offer.

The buyer can be required to enter a set of claim data, some of which may have been entered previously during the process of claiming the EV TD.

The invention can provide a variety of communication channels, including physical mail, for enabling the buyer to make the payoff claim.

The invention provides a method of (or system for) storing a payoff claim.

The payoff claim data, if newly presented by the buyer, will be entered into the system by the buyer and/or by a system administrator who has received the data.

The payoff claim data will include proof-of-purchase data, including:

the product or service that was purchased

the company the purchase was from

the purchaser

the amount of the sale (how much was paid or will be paid)

the date of the purchase.

The payoff claim data will also include proof-that-buyer-meets-targeting-conditions, in which the buyer submits proof that he meets the conditions of the targeting offer. This information will often be in hard copy form, sent to an inspection center, which could also be called a TD redemption or payoff claim center. For example, tax return information, or proof of citizenship or age will often have to be in the form of hard copies of official documents. The physical submission will be identified to correspond to a buyer's payoff claim, and a system operator will enter the required proof-of-claim data into the system to correspond to the claim.

The buyer can also be required to pay an inspection fee. Accordingly, the system can include means for receiving such a fee.

Further, the buyer can be required to put up a deposit to be forfeit if the inspector finds that the buyer does not to meet the conditions of the TD offer. Thus, the system can include means for receiving such a deposit (and confiscating it upon certain conditions).

Maintaining a User's Payoff Claiming History

In order to prevent cheating, it is useful to store all of a user's attempts to claim a payoff. A user who makes payoff claims at a statistically significant rate above average may be indicating that he is a cheater. Thus, as part of the process for enabling a user to claim a payoff, the invention can provide a method of (or system for) storing a payoff claim as part of a user's payoff claim history, which can be a subset of the user's claim history, and which can be made accessible to system operators.

The invention can also provide for giving access to a user's claiming history by a special class of user, a cheat detection inspector or cheat detection expert, who is authorized by the system to review the payoff claim histories of users to detect cheating.

The invention can also provide for displaying a buyer's payoff claim history, or statistics summarizing the claim history, to the buyer himself.

### 1.7 Enabling an Inspector to Verify that a Buyer Meets the Offer Conditions

The invention will include a module for inspecting a payoff claim.

When a buyer has submitted a payoff claim, the invention will assign the claim data a status indicating that the claim data is to be examined by a system-authorized inspector. Thus, to enable an inspector to decide whether the winning buyer has met the offer conditions, the invention will provide a module for:

informing a system-authorized inspector that a claim is to be inspected,

enabling the inspector to inspect the claim data and,

viewing the corresponding TD offer.

The inspection will take place outside of the inventive system, and the inspector will enter the decision of the inspection into the system.

The inventive system can enable an inspector to enter an inspection report explain why he has rejected a claim, i.e., the system can include a standard menu of explanation options (like form-letter responses) that an inspector can select from to explain his claim rejection, or can enable him to enter a custom written explanation of his own.

If the inspector approves a claim, the system passes the inspector's decision to a payment transfer process for transferring the payoff to the buyer.

Storing the Inspection Result for Use in Future Inspections and Non-EV Payments

The invention can also provide for storing the inspection decision in the buyer's user profile to reduce the cost of possible future inspection—i.e., instead of doing a full inspection on the user for a future TD payoff, an inspector can call up the user's profile and use information from the previous inspection report(s).

Once a user's eligibility has been verified, it might be possible to offer him a TD without resort to an inspection, and further, without resort to EV payment. The main reason for the use of EV payment is to justify the cost of inspection, so if an inspection has been done, an EV payment may not be necessary, and a definite payment may be employed.

Whether an inspection can be avoided, and a prior inspection decision can be used will depend on the particular TD.

Thus, the inventive method and system can include both EV payment and, in cases of prior inspection, definite payment. Where definite payment is concerned, the inventive method and system can enable a buyer to request definite payment. This request can be approved by automated means or by a system operator (who may need to be paid for her labor out of the proceeds of the TD).

Methods of transferring definite payment are well known.

Inspecting a Fraction of the Payoff Claims

We expect that in most implementations of the invention, a claimant would have to put up a deposit to ensure that his claim was valid. The deposit would be forfeit in the claim were invalid.

A twist on this idea, to increase the efficiency of inspection, it is to ask claimants to put up a large deposit (to post a bond, so to speak), and only inspect a fraction of the claims, with some pre-set selection method (e.g., random selection of claims). The un-inspected claims would be assumed valid.

Accordingly, the invention can provide a method of (or system for) enabling a winning buyer to submit a deposit into an escrow type account to be released upon a non-inspection or a positive inspection result and to be confiscated upon a negative inspection result

Further, the invention can provide a method of (or system for):

enabling winning buyers to submit a deposit to be put into an escrow-type account, and

selecting winning buyers randomly, and by other pre-determined criteria, for inspection and,
if a winning buyer has not been selected for inspection, assuming that the buyer meets the conditions of the TD offer, paying the winning buyer the payoff, and releasing the deposit from the escrow account,
if a winning buyer has been selected for inspection, inspecting the buyer to verify whether he meets the conditions of the TD offer, and
   if the winning buyer passes the inspection, paying the winning buyer the payoff, and releasing the deposit from the escrow account,
   if the winning buyer fails the inspection, confiscating the buyer's deposit.
      Centering the Invention Around the Use of Deposit (Around the Posting of Bonds)

The present invention uses expected payments to reduce the number of inspections of buyers. It is possible to reduce inspections solely by using the method of having buyers post a bond to vouch for the honesty of their claims, and then auditing a percentage of those buyers.

We do not feel that this will be the dominant approach in the market because it requires people to put up large deposits upfront, but we note the possibility.

The posting of deposits is more likely to be a major addition to the present invention where TD amounts are large, and it can be worthwhile for people to put up a bond to collect the TD amount. The inventive method can enable a buyer to recapture the bond, so that it does not have to be held in escrow for a long period of time.

### 1.8 Enabling a Winning, Eligible Buyer to Be Paid the Payoff

The invention will include a module for transferring a payoff to a winning, eligible buyer.

Once an inspector approves a payoff claim, the inventive method registers that the buyer is owed the payoff. How the TDTS enables payoffs to be transferred from sellers to qualified buyers depends on whether the seller or the TDTS assumes the payoff risk in the bets.

Below we describe two general methods for transferring payment from a seller (a payer of a discount) to qualified buyers. In Part 8, we describe additional methods.

We note that the invention is not limited to these methods but can incorporate other, known methods, such as insurance methods, for transferring money from payers to qualified buyers.

In all cases below, if the TDTS collects payment from sellers, the TDTS will include well-known debit and/or credit account processes. Further, the TDTS will include well-known mechanisms for accepting payment and for notifying a seller when her account has a low balance or an overdue balance. Further, the TDTS will include well-known mechanisms for suspending a seller's TD offer when her balance has fallen below a threshold.

Case 1. Seller Assumes the Risk in the TD Bets

If the seller assumes the payoff risk, the TDTS does not necessarily have to collect payment from her. TDTS can be an accounting machine in the sense that it registers payment obligations but does not transfer actual payment.

In this case, the TDTS includes steps for notifying sellers of their payment obligations and for notifying winning, qualified buyers that they are owed a payoff amount from a given seller.

For example, assume Starbucks is offering a $1 TD, and assume that Ben wins $1,000 in the TD bet based on this offer and, assume that Ben meets the conditions of the offer. Then, TDTS may notify Ben that Starbucks owes him $1,000 and will notify Starbucks that it owes Ben $1,000.

Alternatively, TDTS can include means for transferring payoffs from sellers to winning, qualified buyers. These means include steps for:

establishing a debit (or credit) account for a seller,

receiving funds into in this account and,

transferring a payoff from a seller account to a qualified buyer.

Case 2. TDTS Assumes the Risk in the TD Bets

If the TDTS assumes the payoff risk, it will include means discussed above for establishing a seller payment account. Each time a buyer claims a seller's offer, TDTS will deduct money from the seller's payment (debit) account and transfer it into a TDTS account, and from that TDTS account the system will pay buyers.

But the process is more complicated than that; it is different from a conventional payment transfer system. The problem is that Sela is offering EV TD's only to qualified buyers, but buyers who accept her offer will include qualified buyers and non-qualified buyers.

Assume that Sela offers a $1 TD. Now, assume that 2,000 buyers accept her offer.

How much does Sela owe the TDTS? If she pays $1 per claim, that is not fair because she is only supposed to pay for qualified buyers. She does not know, and TDTS does not know, what percentage of TD offer claimants are qualified.

TDTS cannot know if a particular buyer is qualified unless the uncertainty is resolved by the claimant winning the TD bet and submitting his payoff claim data.

Therefore, to compensate for non-qualified claimants, the TDTS can apply a discount factor to the EV TD amount that Sela offers to buyers. This discount factor is applied to TD offer claims. Each time a buyer claims a TD, Sela would not owe the TDTS the full amount of the EV stated in the offer, but a discounted rate. For example, if the EV amount offered to qualified buyers is $1 and the discount factor is 10%, then TDTS registers that Sela owes 10 cents per TD offer claim.

The goal in a discount factor is to represent the percentage of initial claimants who are qualified buyers. To arrive at a fair discount factor, the general idea is to gather statistics on what percentage of claimants are qualified.

TDTS may include one or more formulas to determine the discount factor for a given seller and the seller's offer. The formulas will use data on how many claimants convert into winning, qualified buyers (how many winning claimants are qualified buyers). These statistics can be gathered from the responses to offers within TDTS that are similar to Sela's offer. The TDTS can feed this response data into the discount formula(s). Other methods, such as survey methods can be used as well to yield discount factor data to be fed into discount formulas as well.

The point here is that if the TDTS assumes the payoff risk it will include:
a discount formula (or formulas) for arriving at a discount factor, to be applied to the EV amount that is offered in an TD offer.

Alternatively, in certain implementations, the TDTS will not include a discount formula, but will include means for enabling a system administrator to enter a discount factor.

Further, when a buyer claims a TD, the TDTS will:

apply the appropriate discount factor to the EV payment,

deduct the resulting amount from the seller's debit account,

transfer the amount to a TDTS account that is used to pay winning, qualified buyers.

Further, in the inspection process, when an the inspector approves a claim, the TDTS will:
register that the buyer is owed the payoff from the TDTS account that is used to pay winning buyers.
   Case 3. TDTS Enables the Seller to Choose to Take the Risk in EVPM Bets

TDTS can enable a seller to choose whether or not to assume the payoff risk. The system would simply include both kinds of payment processes discussed above. In this case, TDTS could enable Sela to check a box in the process of establishing her account in which she signifies that she will take the payoff risk in all payment offers to buyers. Alternatively, the TDTS form for entering a TD offer can include a box where Sela signifies that she will take the payoff risk for that particular offer.

### 1.9 Enabling Reports that Show Sellers the Responses to a TD Offer

The invention can include a module for providing seller reports of TD claiming activity.

A seller will want to evaluate the response to her TD offers.

Thus, the invention can provide a method of (or system for) generating reports that can include, but are not limited to, the following information:

the number of people claiming a TD offer,

the number of claimants who win TD bets,

the number of claimants who win TD bets and successfully pass an inspection,

the total amount of money spent on a TD offer,

the demographics of the claimants.

This report information can be shown as a function of time as well, for instance, how many claims for a TD offer are made per day.

### Part 2

### Embodiments in which the Buyer Claims an EV Targeted Discount by Matching a Number Associated with His Proof-of-Purchase Against a Public Random Number

Contents of Part 2

1. Low Initial Transaction Cost Method of Claiming a TD

2. Entering Claim Data

3. Methods for Preventing the Forgery Cheat

4. Methods for Preventing the Identity Switch Cheat

Low Initial Transaction Cost Method of Claiming a TD

One method for both executing a TD bet and enabling a buyer to claim a TD is to have the receipt—or other proof-of-purchase—carry a number that is to be matched at a future date against a public random number, used for the purpose of deciding TD bets. In other words, to turn the receipt into a lottery ticket with a specified expected value, in which the holder checks a publicly published random number to see if the ticket is a winner.

Assume, for instance, that a TD bet has a pre-set probability of 0.01 for a winning result. And assume that the public random number being used is the last two digits of a specified state lottery number, announced on specified date. Finally, assume that Ben purchase a movie ticket that also has a match number printed on it, such as, “17.” Then, if the specified state lottery number ends in “17” on the specified date, Ben's ticket is a winner.

This method of turning a proof-of-purchase into a lottery ticket with a specified EV—where EV=TD—can be applied to any purchase situation, whether the purchase is in-person, over the phone, via mail, or online.

The public, random number can be generated by an outside agency, such as a lottery authority, or by the inventive system, or by a publicly published formula.

Advantages of the Method

One advantage of this method is a low initial transaction cost for a buyer, especially when a purchase is made in-person, as for instance, a purchase of a movie ticket. For the seller, an advantage is that discount payouts may be lower than advertised on average because a significant fraction of buyers will forget to check if they won or lost a TD bet, and another fraction of buyers will lose their proof-of-purchase.

Steps of the Method

The invention can provide a method of (or system for) enabling a seller to:
set a probability of a buyer winning a TD bet,
associate a match number (or a set of match numbers) with the buyer's receipt (or other proof-of-purchase) from a purchase,
said match number to be matched against a publicly displayed random number, randomly chosen from a specified range of numbers, such that the probability of the match number matching the random number equals the probability of a buyer winning the TD bet,
said publicly displayed random number being revealed at a specified date, known to the buyer, so that the buyer can check the public random number to see if he has won the TD bet.

A seller can associate a match number with a receipt by printing the number on the receipt, for instance. Another method is to use a public formula that converts data on the receipt into a random number, which may, or may not be printed on the receipt. Another method is to provide the buyer with a separate random number carrier, similar to a lottery ticket, which contains the random number and is identified in some way with the receipt.

The public random number would usually be displayed at a time after the buyer had the opportunity to return the purchase, for example, 30 days after a purchase. Otherwise, a buyer could make a purchase simply in order to see if he would win the corresponding TD bet. Upon losing a TD bet, he could return the purchase.

### EXAMPLE OF THE USE OF THE METHOD

As an example of how the method above might be implemented, assume that a movie theater offers a $2 per ticket discount to people whose family income is under $20,000.

The theater uses the method above and, thus, prints each movie ticket with a single match number from 00-99, for instance, “17.”

Assume that the terms of the TD bet are that the buyer has a 0.01 probability of winning $200, which equates to an EV of $2.

Assume that the publicly displayed random is the last two digits of the state's daily Pick 3 Lotto game, such that the number that applies to the TD bet is the number displayed for the Pick 3 game on the day after a movie ticket is purchased. For example, a ticket purchased on Monday will have a match number that is to be matched against the last two digits of the Pick 3 number of Tuesday's game. Assume a Ben buys a movie ticket. Then, the day after the movie, the state Pick 3 Lotto number is displayed and Ben can find out if he has won. If he has won, then he can take steps to claim the payoff.

“Instant Win” Option

Where purchases cannot be returned, a seller can provide an instant TD bet result. A buyer could be provided with an “instant win” piece, like a scratch-off lottery ticket. The lottery ticket would be associated with the receipt in some way, or that association would be validated by a salesperson. If the non-returnable purchase was electronic, for instance, an online purchase of a song, an instant win could be provided by automated means.

Entering TD Claim Data

Under the method above, after a buyer has found out that he has won the TD bet, the inventive system can enable him to enter payoff claim data. However, the method above can include additional steps of requiring a buyer to enter information before he can find out if he has won the TD bet—in other words, the buyer may be required to enter some data in order to claim the TD.
The buyer may be required to provide proof of identification, which becomes associated with the receipt.
The buyer may be required to make a statement of eligibility, which becomes associated with the receipt.

This information can be electronically recorded to be associated with the receipt, or an employee of the seller can stamp the information on the receipt. Associating this kind of information with a receipt can be useful to deter cheating.

Entering Payoff Claim Data

Under the method above, after a buyer has found out that he has won the TD bet, the inventive system enables him to enter payoff claim data. As noted, some of this data can, potentially, be provided before the TD bet result is revealed.

If the purchase is electronic, the invention can provide steps for enabling the winning buyer to submit proof-of-purchase electronically. If the proof of purchase is a physical receipt, without an electronic copy that can be submitted, then the buyer will have to physically send the proof-of-purchase to an inspection center, where a system operator will enter the proof-of-purchase information into the system.

Other information for verifying that a buyer meets the TD targeting conditions will often also have to be sent physically to an inspection center. For example, tax return information may have to be sent in hard copy form to a redemption center.

Methods for Preventing the Forgery Cheat

If a number is physically stamped or affixed to a receipt, or if a separate number piece is physically associated with a receipt, the number can potentially be forged to yield a winning number. Further, the proof-of-purchase itself may be forged. Methods for preventing forgery are well known. In addition to physical methods, the inventive method can include the step of storing the number that is associated with a receipt, making forgery pointless because a buyer cannot change the stored record. The inventive method can also include a pre-determined formula for associating receipt data with match numbers, also making forgery pointless.

Methods for Preventing the Identity Switch Cheat

Another cheat is one that can be used against all of the embodiments of this specification, which we will call the identity switch cheat.

Let us continue with the movie ticket example above to illustrate. Assume that Ben above has won his TD bet and that he can collect $200 if he proves that his family's income is <$20,000. But, assume further that Ben's family's income is over $100,000, then Ben must find someone else whose family's income is <$20,000 to switch identities with Ben to claim the payoff. Assume that Ben finds this person, call him Iggy, and that Iggy then claims the payoff using, for instance, his family's tax return as proof that he meets the conditions of the TD offer.

There are many ways to deter this cheat. We cannot be exhaustive, but we will describe several, some of which will also apply to other embodiments of this specification. The descriptions below are not intended to limit the scope of the invention, which can include any appropriate authentication technology that prevents a post-sale switch in identities.

If the purchase is in-person, the buyer can be required to show identification, and the buyer's name can be associated with the receipt, e.g., through a credit card receipt, or a check receipt, or a smartcard record, or by a sales clerk writing the buyer's name on the receipt at the point of sale. These same kinds of identification means can be employed if the purchase is online, or by phone, or by mail. In addition, if a purchase is electronic, a biometric sample can be captured from the buyer and stored to be compared later to a corresponding sample from the claimant of the payoff (a variety of such techniques were described in U.S. patent application Ser. No. 10/700,836, incorporated by reference).

A host of question-answer techniques can also be used, whereby a buyer is asked questions that only he should be able to answer. Then the same questions can be asked of the claimant (a variety of such techniques were described in U.S. patent application Ser. No. 10/700,836, incorporated by reference). If a purchase is in-person, another method can be used, although it probably will not be. That is to take a picture of the payoff claimant to the sales clerk who sold the product in question to the buyer. The sales clerk would have to verify that the payoff claimant and the buyer were the same person.

Using Claiming Histories and Two-Stage Betting Processes to Detect Cheating

As described above, in Sections 1.3, 1.4 and 1.6, the invention can provide for maintaining claiming histories. A cheat detecting inspector can examine a user's claiming history to possibly detect an identity switch cheat. For example, if a buyer who claims to have income under $5,000 and has a claiming record indicating purchases of $5,000, then an identity switch cheat may be suspected. To register more claims, and more purchase data, and hence more information that can be used to detect cheating, a multi-stage betting process can be employed (see Section 1.4) so a buyer will have more chances to enter payoff claims describing his purchases and himself.

### Part 3

### Embodiments in which the Buyer Claims an EV Targeted Discount by Communicating with a Targeted Discount Transaction System

Contents of Part 3

1. Transactional Directory Method for Providing Targeted Discounts

2. Illustration

3. Methods for Preventing the Double-Claiming Cheat

4. Methods for Preventing the Identity Switch Cheat

Transactional Directory Method for Providing Targeted Discounts

All modules of Part 1 can be implemented within a transactional directory system.

This kind of directory enables a seller to post a TD offer. And it enables a buyer to find the offer, to claim the offer, to execute the TD payment bet, and to claim a payoff. Further, it enables an inspector to inspect a payoff claim and enter a decision, validating or rejecting the payoff claim, and authorizing or blocking a payoff payment to a buyer.

As described in Part 1, the invention provides a module for enabling a seller to enter an offer (see Part 1, Section 1.1), which can be defined and identified through a variety of parameters, names, and conditions, such as: seller name, product name, location, amount of money to be spent, and so forth (see also Section 1.2). It is also possible for an offer to be identified by a unique, serial number type code, obviating the need for search criteria, other than the code.

A directory system for transacting EV TD's can also enable a buyer to enter search criteria to find a TD offer using any of the parameters/information that the seller used to define and describe the offer.

This kind of directory will also enable a buyer who has found an offer to select the offer to signify that the buyer is claiming the associated TD—is accepting the offer, that is.

The transactional directory can then execute the corresponding TD bet and inform the buyer of the result, after a time period specified by the seller (or by default).

The directory can further enable a winning buyer to submit payoff claim data, which the directory then passes onto a system-authorized inspector for inspection.

The directory can further enable an inspector to inform the winning buyer of the inspection decision.

The directory will include a buyer registration process so that Ben's claim can be identified and so that the system can communicate with Ben about a winning result, if any, and so that the system can store Ben's registration information for the claiming of other offers, and for authentication purposes, and for analysis by anti-cheating processes.

This kind of directory system can be used regardless of how a product is purchased.

Illustration

Let us assume that a directory system enables Ben to find an offer using search criteria. Let us further assume that he enters the term Westin Hotels and finds a large number of matching offers. He could then, we imagine, narrow his search by location of the Westin Hotel, by size of room, or by other criteria. Assume, then, that he has narrowed his search down to an offer or offers that correspond(s) to one particular product, a one-room suite in Santa Monica.

As discussed in Section 1.2, he can further narrow his search according to his eligibility.

So, assume he has found a 10% TD that he is eligible for if he purchases a stay in a one-room suite at the Westin in Santa Monica.

The invention can be implemented to enable Ben to claim a TD before or after he has made a purchase, or during the purchase process (as when a coupon is redeemed at the time of purchase).

If Ben is planning to buy, then the directory can enable him to enter the planned date of his purchase, since the system will need this date in order to set the date for revealing the result of Ben's TD bet.

If Ben is claiming a TD at the time of a purchase, the directory can receive automated information about the purchase from the merchant system doing the selling; that is, this merchant system will communicate with the directory. The merchant system might send Ben to the directory, or the directory might send Ben to the merchant system. Either way, both the merchant and directory system will communicate about Ben's purchase.

If Ben is claiming a TD after a purchase (as when a rebate form is sent in after a purchase is made) the directory will enable him to select and claim the TD offer by clicking on a button or the doing the equivalent, depending on the implementation.

The directory can also include steps for enabling Ben to print out a redemption form that corresponds to the TD that he is claiming. In this case, he would have to enter some of all of the claim data on the paper form and send/fax the form to a redemption center. In this case, a system operator who receives the paper submission can enter the claim data into the inventive system. Some sellers might prefer this method because it discourages buyers from claiming their EV TD's.

After Ben claims a TD offer, the system executes the TD bet and, at a pre-determined period of time after the purchase date, reveals the result of the bet. The result can be instantly revealed for non-refundable purchases, such as hotel room stay, provided that the purchase has taken place, of course, and is not just a planned purchase.

The directory can inform Ben of the result in any of a number of well-known ways, including screen alerts and email.

If the result is a win, the directory instructs Ben on how to enter a payoff claim including proof-of-purchase. We note that in some implementations, proof of purchase may be automatically verifiable, as when an online merchant system's database can communicate with the directory.

The same directory system can be used to inform an inspector of the need to inspect a claim, and can further enable an inspector to enter a decision and to communicate that decision to a buyer, as described in Section 1.7.

Payoff payment can be effected as described in Section 1.8 and Part 8.

Methods for Preventing the Double Claiming Cheat

Buyers might try to cheat the system above by double claiming TD offers. Multiple claims by a single user can be stopped by identifying the user and eliminating, or discounting for, the duplicate claims. What if multiple identities are used for the same purchase? For example, what if three family members who share a hotel room claim the discount for that hotel room? To prevent this cheat, a meta-rule of the invention can be that the name on the proof-of-purchase must match the buyer who claims the TD. Where cash purchases are concerned, and there is no name associated with the proof of purchase, a meta rule can be that the proof of purchase must have the buyer's name written on it by a sales clerk, or by some other equivalent way of identifying who the purchaser is. Thus, we see that this cheat is basically equivalent to the identity switch cheat described in Part 2.

Methods for Preventing the Identity Switch Cheat

The methods described in Part 2 for preventing the identity switch cheat can be employed in the directory embodiments of this Part 3 as well.

### Part 4

### Embodiments in which the Seller Submits the Buyer's EV Targeted Discount Claim to the Targeted Discount Transaction System

Contents of Part 4

1. Methods in which the Seller Submits the Buyer's EV TD claim

2. Methods for Preventing the Identity Switch Cheat

Methods in which the Seller Submits the Buyer's EV TD Claim

All modules of Part 1 can be implemented within a transactional a system that enables sellers to submit TD claims on behalf of buyers.

This kind of system can be used regardless of how a product is purchased, and is especially useful where sellers have the computing infrastructure to send a claim to the TDTS. By analogy, we can think of a supermarket scanning in a coupon for a customer, or an online merchant enabling a buyer to take advantage of a coupon. In this case, though, the discount is a TD discount and payment is accomplished via EV payment bets.

At minimum, if the seller submits the claim, the seller will have to record:
the buyer's contact data, to contact him in case he wins the TD bet,
the name of the product that the TD offer applies to, or other information for identifying the purchase that the TD offer applies to, so that the TDTS can execute a bet for that TD claim and report the result of that bet.

Initially, using this method, the buyer's eligibility does not necessarily have to be recorded. That's because there may be only one class of eligibility.

Or, if there is more than one type of eligibility, then a random selection can be executed such that the buyer has a 1/N probability of winning. If he wins, he can submit more claim information, to be verified, and possibly, to enable a second payment bet.

Let us assume that Ben is purchasing a book at a store. At the register, the sales clerk asks him if he wants to take advantage of a TD offer. Ben says, “yes.”

The clerk asks Ben for his phone number or email address or other contact data. The clerk enters this information into the register, which we will assume is a computer terminal that can enter information for a TD claim.

The contact data is associated with the particular purchase data, and the two kinds of data are sent together to the TDTS as a claim. Then, the TDTS registers contact and purchase information associated together as a claim and executes an EV payment bet where the probability of Ben winning is 1/N. (If the eligibility is clear and the TD offer terms are set, then the probability can be set at (Static TD Amount)/Payoff.)

If Ben wins, the TDTS contacts him, by any well-known means, and tells him of the result and instructs him on how to provide payoff claim information. This same procedure can be applied to any sales channel, whether online, phone, or mail order.

In cases where the point of sale does not have a computer that can store and send the claim data, a sales clerk can take down the buyer's contact information and the purchase information and send it by mail or fax to a TDTS mailstop or faxstop where a system operator can enter the information. It is even possible in this case to have the claim physically selected randomly, but we will not delve into this possibility.

Methods for Preventing the Identity Switch Cheat

The methods described in Part 2 for preventing the identity switch cheat can be employed in the embodiments of this Part 4 as well.

### Part 5

### Embodiments in Embodiments in which a Condition for Receiving a Targeted Discount Is a Means Test

Contents

1. Embodiments Enabling a Means Test for TD Eligibility

2. Steps for Entering a TD Offer with a Means Test

3. Steps for Finding and Claiming a TD Offer with a Means Test

4. Steps for Inspecting a Payoff Claim for a TD Offer with a Means Test

5. Steps for Preventing the Identity Switch Cheat in a TD Offer with a Means Test

### Embodiments with a Means Test for TD Eligibility

One kind of TD that can be widely useful is a discount that is targeted to people according to their financial condition—in other words, a TD that is offered to people according to a means test. For example, a seller of textbooks might want to offer a discount to students who come from poor households. Likewise, a gourmet coffee shop might want to provide discounts on coffee drinks to senior citizens, but only those seniors who have a low net worth. Likewise, a hotel chain might want to provide rooms to lower income families at a substantial discount.

An obstacle to offering these discounts is that they require people to provide evidence of their financial condition, which people may be reticent to do, which may require a substantial effort, and which may require a costly verification. An EV TD in which the payoff is high enough can overcome these problems.

The invention can include steps for enabling a seller of offer a TD with a means test, and for buyers to claim such a TD. We will describe these steps, which can be added to previously described modules.

Steps for Entering a TD Offer with a Means Test

Here we describe steps that are added to the previously described steps for entering a TD offer (see Section 1.1). The invention can provide a form or the equivalent for a seller to enter a means test requirement that a buyer must meet to be eligible for the TD.

Means test is a broad idea that can cover a wide variety of specific tests of a person's financial condition. We will use the term means test to refer to the general idea of a means test and also to the specific condition that a buyer must meet, the concrete requirement or measure of the means test. The invention can provide a method of (or system for) entering a TD offer that includes a specific means test requirement or requirements.

A means test can be, but is not limited to, a requirement that a buyer has:

an income in a specified range, and/or,

a net income in a specified range, and/or,

an after-tax income in a specified range, and/or,

a disposable income (defined in any of a variety of ways), in a specified range, and/or,

a net worth, in a specified range, and/or,

credit rating in a specified range.

A means test may refer not just to the buyer's financial condition, but also to a buyer's family's financial condition. Thus, a means test can be, but is not limited to, a requirement that a family's income and/or net income and/or after-tax income and/or disposable income and/or net worth and/or credit rating, and so forth, all into specified range. Family can be defined in any of a variety of ways. If some measure of a family's financial condition is used as a means test, then the system can also enable a seller to stipulate that a buyer's family's financial condition if the buyer is financially severed from his family.

The offer entry form can further enable a seller to set a discount to correspond to a particular measure of a buyer's financial condition. Thus, a seller can set more than one discount amount to correspond to more than one measure of a buyer's means, such as a 20% discount for buyers with an after-tax income of less than $10,000, and a 10% discount for buyers with an after-tax income between $10,000 and $20,000.

Another kinds of means test that the invention can enable a seller to state in a TD offer is a requirement that a buyer or a buyer's family are receiving specified public assistance.

A different kind of means test requirement is where a buyer lives or works or hails from. Thus, a means test requirement can be where a person lives, country, state, province, city, zip code, or neighborhood. For example, a textbook publisher might want to offer TD discounts to students in Ghana, or students who are Ghanaian citizens, or students who live in East St. Louis.

Yet another means test requirement can be one that is a “negative test” that defines products or services that a buyer cannot have bought in the past. For example, a seller might want to make TD offers available to people who are poor, but not if those people “squander” their money on certain types of products and services. For example, a seller might stipulate that a buyer cannot have spent more than $30,000 on his car, or more than $10,000 on jewelry. Thus, a means test requirement can include a list of products that a user cannot have bought, or an amount of money that a user cannot have spent on a particular set of products.

A means test can include conditions other than the means test requirements. An especially useful condition is the age of a buyer. For example, TD discounts can be offered to people whose families have incomes under $20,000 and who are 15 years old or less. Thus, a means tested TD can enable a poor child or student to receive discounts.

As part of a means tested TD offer, a seller can state the kind of evidence that is required to verify that a buyer meets the means test, e.g., a tax return or a specified document demonstrating that a buyer's family receives public assistance.

Steps for Finding and Claiming a TD Offer with a Means Test

A TD offer with a means test may be advertised in a variety of ways. Thus, a buyer can find the offer outside the inventive system.

It is also possible to post the offers in a directory, as described in Part 3. In this case, the directory will enable a buyer to enter search criteria that include a means test information in order to find TD offers. For example, a buyer could enter his after-tax income to find TD offers that apply to him.

Steps for Inspecting a Payoff Claim for a TD Offer with a Means Test

The steps for inspecting a payoff claim where a buyer must meet a means test are basically the same as the previously described steps for enabling inspection of any payoff claim. The invention can also provide specialized forms for enabling an inspector to enter: financial information about a buyer, such as tax return information, and for stating in an explanation why the buyer does or does not meet the means test requirement(s).

Steps for Preventing the Identity Switch Cheat in a TD Offer with a Means Test

An example of an identity switch cheat for a means test was described above in Part 2.

Generally speaking, in this cheat, a “rich” person (a person not meeting the means test) claims a TD and wins the TD bet. The rich buyer then finds a poor person (a person who does meet the means test) to claim the TD bet payoff.

The methods described in Part 2 for preventing the identity switch cheat can also be employed to prevent this cheat in a means test embodiment of this Part 5.

Another method can be employed as well in which statistical tests are applied to the number of TD claims that a buyer makes. As described in Sections 1.3 and 1.6, a buyer's claiming history can be compiled, and statistical tests can be applied to this history.

A buyer who claims TD at a statistically higher rate than average may be indicating that he is cheating. For example, if a poor buyer makes TD claims for $20,000 in purchases that may indicate that he is actually fronting for the purchases of someone who is rich.

Thus, the invention can provide a method of (or system for):

storing a user's TD and payoff claims in a user history,

subjecting the claim data to statistical tests to provide a statistical measure of the veracity of the claiming history,

flagging a user whose claiming history has a statistical measure that is greater than a pre-determined threshold.

If a user has been flagged, an inspector can automatically disqualify the user or can investigate further. Another way to deter the TD offer cheat is to simply inspect other purchases that a buyer has made and disqualify those users who have made certain kinds of purchases, which might or might not be defined in the TD offer.

### Part 6

### Embodiments in which a Condition for Receiving a Targeted Discount is that the Buyer is Buying from the Seller for the First Time

Contents

1. Embodiments Enabling a First-Time Purchaser Condition for TD Eligibility

2. Steps for Entering a TD Offer with a First-Time Purchase Condition

3. Steps for Preventing Double Claiming

### Embodiments with a First-Time Purchaser Condition for TD Eligibility

One kind of TD that can be useful is a discount that is targeted to people who buy from a seller for the first time. A seller may want to offer a discount to first-time prospects as an inducement to try the seller's product. For example, a restaurant might want to offer a 50% discount to people who try the restaurant for the first time. We might call such a discount a trybate.

An obstacle to offering a trybate is that it requires a buyer to provide evidence that he is a first-time buyer, a condition that can cost a lot to verify. One way to verify that a buyer meets such a condition is to use an EV TD discount and inspect the buyer only if he wins the TD bet.

Steps for Entering a TD Offer with a First-Time Purchase Condition

In addition to the steps previously described steps for entering a TD offer (see Section 1.1), the invention can provide steps for entering a TD offer that includes the requirement that the buyer is purchasing from the seller for the first time.

The invention can also enable a seller to enter that first-time-per-family offer, such that the first-time buyer condition is only available once to a family. That is, if one person in a family claims the trybate, no one else in the family can claim the same trybate. Family can be defined in any number of ways by a seller, or by a default.

Steps for Preventing Double Claiming

One cheat against a TD offer with a first-time buying condition is the identity switch cheat. The methods previously described for deterring this cheat can also be used in the embodiments of the invention that enable a first-time buying condition.

Another cheat is to use ones true identity and still falsely claim to be a first-time buyer. To prevent this from happening, TD offer claims need to be registered in a central database so that a buyer's duplicate claims can be eliminated. As described above, the invention can include a method for eliminating duplicate claims.

A buyer can try to avoid the elimination of duplicate claims by using a family member to make a purchase. For instance, a husband may make a purchase on one night at a restaurant, and his wife may make the purchase the second night. Therefore, additional de-duplication tests can be applied, in addition to matching names. Addresses can be matched and de-duplicated. Further, an inspector can check to see who is in a winning buyer's family and can potentially disqualify people whose family members live in different locations.

If TD claims are initially NOT de-duplicated, then the inventive method can include a two-stage, parlay bet process in which buyers who win a “first-stage bet” are registered. If a buyer has more than one first-stage win for an EV trybate from a particular seller, then the buyer's claims can be disqualified. This method of detecting multiple claims for a trybate is not perfect but it can cut down on the double-claiming cheat.

### Part 7

### Embodiments in which a Condition for Receiving a Targeted Discount is that the Buyer or Buyer's Child Has Performed at a Specified Level in School

Contents

1. Embodiments Enabling an Academic Performance Condition for TD Eligibility

2. Steps for Entering a TD Offer with an Academic Performance Condition

3. Steps for Claiming a TD Offer with an Academic Performance Condition

### Embodiments Enabling an Academic Performance Condition

One kind of TD that can be useful is a discount that is targeted to students who perform at a certain level in school and/or on tests. This kind of discount can also be targeted to parents of students. For example, a store might offer a 3% discount on all products to parents whose children get above 600 points on a national achievement test.

An obstacle to offering a rebate based on academic performance, including test scores, is that it can cost a lot to verify the performance relevant to the discount.

One way to cost-effectively verify that a buyer meets an academic performance condition is to use an EV TD discount and inspect the buyer only if he wins the TD bet.

Steps for Entering a TD Offer with a First-Time Purchase Condition

In addition to the steps previously described steps for entering a TD offer (see Section 1.1), the invention can provide steps for entering a TD offer that includes the requirement that the buyer has performed at a specified academic level, as defined by grades or over a given level on test scores, such as achievement test scores. The module for entering an offer can include fields for specifying the particular grades or grade point average or test score(s) and the corresponding discounts.

The offer entry form can enable a seller to set a discount to correspond to a particular level of performance. For example, a movie theater chain could offer:

| | |
|---|---|
| grade point average >= 3.5 | 10% discount |
| grade point average >= 3.0 | 5% discount |
| achievement test >= 600 | 15% discount |

Steps for Claiming a TD Offer with an Academic Performance Condition

There is not much to add from previous description of claiming a TD offer, except to say that the inventive system can include search means for enabling a buyer to find and claim an offer by using descriptions of academic performance, such as a grade point average, as search criteria.

### Part 8

### Methods for Transferring Payment from Sellers to Qualified Buyers

Section 1.8 described methods for transferring a payoff from a source payer, the seller offering a TD, to a winning, qualified buyer. In this Part 8 we repeat the methods above and describe additional methods for transferring payment. This Part 8 is a copy of the Description of U.S. application Ser. No. 10/811,643, Methods for Transferring Payment in EV Payment and Verification Systems, referenced above, by the same author as this specification. The author includes this copy in case it is useful for patenting purposes.

In this Part 8, the invention and the inventive method will refer to the inventive methods described in this Part 8. Likewise, the invention and the inventive system will refer to the inventive systems described in this Part 8.

The methods described in this Part 8 apply to situations in which a payment system enables a payer to pay a recipient an EV payment provided that the recipient meets specified conditions that are verified and/or tracked using the system.

This Part 8 elaborates on a method of using two EV payment bets to transfer a payment from a payer, through a system, to a recipient. In this method, the payer takes the payoff risk in the first bet while the system takes the payoff risk in the second bet.

In addition, this Part 8 describes a method for paying an EV amount that is based on a percentage of a purchase amount. This description is included here for the sake of completeness, but has already been disclosed in the above referenced applications.

In addition, this Part 8 describes how EV payments can be capped when EV payment is based upon a percentage of a purchase amount.

In addition, this Part 8 repeats descriptions in one or more of the above referenced applications of how transaction costs can be reduced with the use of deposits.

Contents of Part 8

Introduction:

How the Specification of Part 8 is Written

Where the Inventive Methods Apply

Inspection (Verification) Process Reviewed

Example Scenario

Definitions for Part 8

(Note: “Sections” below refer to Sections of this Part 8)

Section A: Payer Takes All the Payoff Risk
Section B: System Takes All the Payoff Risk and Refunds Invalid Payoff Claims to Payer
Section C: Two-Bet Process Where Payer and System Take Separate Payoff Risk, in which the First Bet Payoff Is Deducted from Payer
Section D: System Takes All the Payoff Risk and Uses a Discount Formula to Adjust for Invalid Claims
Section E: Two-Bet Processes in Which EV Payment Equals a Percentage of a Sale
Section F: Using Deposits to Reduce Inspection Costs
Section G: Miscellaneous Sub-Methods for Efficient and User-Friendly Transactions

### Introduction

How this Specification of Part 8 is Written

This specification is organized as a set of descriptions of modules (sub-processes) that together comprise the inventive method. The modules are high-level descriptions that we use for clarity. The modules themselves can be decomposed into smaller sets of steps, and rearranged, as is apparent to those skilled in technical writing or programming. The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure. Example cases are provided. Those skilled in the art will know that these examples are illustrative only and do not limit the range of applications of the present invention. Many of the options described in this specification, such as certain terms of EV payment bets, may be held standard in practice. Those skilled in the art will readily see where a user option may be converted into a default. We omit descriptions of the various methods that the inventive systems can include for charging users because these methods are well known and do not add to the disclosure.

Where the Inventive Methods Apply

The methods described in this Part 8 apply in payment systems operated according to a method that enables a payer to pay a recipient an EV payment, if the recipient meets specified conditions, which are probabilistically verified and/or tracked using the system.

We call this method the expected value method for paying and verifying (EVMPV). We call an online database system operated according to the EVMPV by the name expected value system for paying and verifying (EVSPV).

The EVMPV is a method for operating an online database system comprising the following elements and steps that are tailored in novel ways to solve specific problems:
1. A payer ID and bank account are established
2. A system account bank account exists
3. A payer posts a payment offer in the system
4. The offer is findable and selectable (acceptable) by recipient who can thus submit a claim for the payment offered
5. A recipient account, including a recipient ID, is registered
6. A recipient's claim submission is registered
7. An EV payment bet is executed to determine whether the claim submitted is worth a payoff multiple of its original value
8. If the claim is a winner, the submitter is informed that the claim is provisionally worth the payoff of the EV payment bet
9. If the submitter claims the payoff from the bet, a payoff claim is registered and a system-authorized inspector verifies whether the payment offer conditions were met
   a. Upon a negative determination entered by the inspector, the system registers that, the payoff claim is disqualified
   b. Upon a positive determination entered by the inspector, the system registers that the claim is worth the EV payment bet payoff.

Methods and systems employing variations of the method above were disclosed in patent applications filed by the author, including patent application Ser. Nos. 09/536,727 and 10/042,975 describing a method and system for paying qualified audiences for attention to sales messages; patent application Ser. No. 10/424,190 describing a method and system for paying commissions to referrers and; provisional application 60/529,071 describing a method and system for paying targeted discounts to qualified buyers.

All these applications are incorporated by reference.

This Part 8 describes several methods for transferring payments from payers to recipients within an EVMPV and an EVSPV. This Part 8 does not concern itself with all the steps of an EVMPV, but with the payment transfer steps.

Note: In all cases below, if the EVSPV collects payment from payers, the EVSPV will include well-known debit and/or credit account processes. Further, the EVSPV will include well-known mechanisms for accepting payment and for notifying a payer and/or for suspending a payer's offer when her account has a low balance or an overdue balance.

Inspection (Verification) Process Reviewed

The EVMPV and EVSPV include steps for triggering a verification process, which we usually call an inspection process, and for registering the results of the inspection.

Let us briefly review an inspection process in the EVSPV so we can refer back to it.

When a user has submitted a payoff claim, the EVSPV (the system) will assign the claim data a status indicating that the claim data is to be examined by a system-authorized inspector. Thus, to enable an inspector to decide whether the user has met the offer conditions, the invention will provide a module for:

informing a system-authorized inspector that a claim is to be inspected,

enabling the inspector to inspect the claim data and,

enabling the inspector to view the corresponding payment offer.

The inspection will take place outside of the inventive system, and the inspector will enter the decision of the inspection into the system.

The system can enable an inspector to enter an inspection report explaining why he has rejected a claim, i.e., the system can include a standard menu of explanation options (like form-letter responses) that an inspector can select from to explain his claim rejection, or can enable him to enter a custom written explanation of his own.

If the inspector approves a claim, the system passes the inspector's decision to a payment transfer process for transferring the payoff to the user.

### EXAMPLE SCENARIOS

In this specification, we will use a single scenario to make the methods disclosed clear. For this scenario, we assume that an EVSPV is implemented within an online database that is a “service bureau” for more than one payer.

Second, we assume a payer, called BestSitter, that provides babysitting services, and that uses the EVSPV to make and transact payment offers.

Third, we assume that BestSitter has established a user account, including bank account.

Fourth, we assume the BestSitter posts three different kinds of payment offers: an offer to pay qualified prospects to view BestSitter's website, an offer to give a discount to qualified lower-income families, and an offer to pay people who refer in customers.

We note that the invention is not limited to these scenarios or to the types of payment offers described in these scenarios.

Definitions for Part 8

EVMPV. See above.

EVSPV. See above.

Payer. A person or organization (or an agent) offering an EV payment using the EVSPV. For convenience, also referred to as Paula.

Payer Bank Account. An account, maintained in the system, in which a payer deposits money (or a virtual account for keeping track of what the payer owes).

Payment Offer. An offer to pay a person or organization that meets/fits specified conditions a specified amount of money or a specified percentage of a sale (a sale is meant broadly to encompass any money or commodity transaction).

Recipient. A person or organization (or an agent) submitting a claim for payment. Also called a claimant. For convenience, also referred to as Reece.

System Bank Account. An account, maintained in the system for the system's money, to receive payment from payers and give payment to recipients (and possibly to send money to another system account for keeping system revenues).

Claim. A claim submitted for an EV payment corresponding to an EV payment offer.

Payoff claim. A claim submitted for a payoff from a winning EV payment claim.

Inspector. A system-authorized user who (1) decides whether a payoff claim is valid and (2) provides the inspection decision to the EVSPV.

### Section A

### Payer Takes all the Payoff Risk

How the EVSPV enables payoffs to be transferred from payers to recipients depends on who takes the payoff risk. In this Section A, we assume that the payer takes all the payoff risk.

If the payer assumes all the payoff risk that means that the payer has to pay the full payoff if a claim “wins” the payment bet that the EVSPV executes.

In this case, the system does not necessarily have to collect payment; it can be an accounting machine in the sense that it registers payment obligations but does not transfer actual payment. Thus, the system can include steps for notifying payers of their payment obligations and for notifying winning, qualified claimants that they are owed a payoff amount from a given payer.

For example, assume BestSitter is offering $10 EV to referrers, and assume that Ray, a referrer, wins $1,000 in the payment bet based on this offer, and assume that Ray meets the conditions of the offer. Then, EVSPV will notify Ray that BestSitter owes him $1,000 and will notify BestSitter that it owes Ray $1,000.

Alternatively, EVSPV can include a process for transferring payoffs from payers to winning, qualified claimants. This process includes steps for:
establishing a bank account for a payer,
receiving funds into in this account and,
transferring a payoff from the payer's account to a qualified claimant who has a winning, inspected, valid claim.
   Using a Two-Bet (“Parlay”) Process

Instead of using a single bet, an EVMPV and EVSPV can use a two-(or more)-bet process.

Accordingly, the invention provides a method for operating an EVSPV including the steps of:

execute a first bet in which Reece's payment claim has a given, first EV=x, and a First Payoff=y,

if Reece's claim loses this first bet, then set the claim value to zero, and do not continue executing bets for the claim,

if Reece's claim wins this first bet, then execute a second bet in which Reece's claim has an EV=y, and a Second Payoff=z,
if Reece's claim loses this second bet, then set the claim value to zero, store the result, and do not continue executing bets for the claim,
if Reece's claim wins this second bet, credit Reece's claim with provisional value=z.

One advantage of a parlay bet is that an initial bet payoff may not be enough to justify doing an inspection, but may justify inducing a claimant to supply payoff claim information, which can be used to set the terms of a second bet that has a higher EV and payoff than in the first bet (see Section E for an example case).

Another advantage of a two-bet process is that an EV payment claimant can be informed if he has won the first stage bet, and can be queried as to whether he meets the terms of the payment offers. The claimant's response can then be registered in a claims database and a user database.

For example, assume BestSitters offers Reece $1EV if he calls BestSitters, and if he buys babysitting services within 2 weeks of making the call. And assume that Reece calls BestSitters, using an EVSPV that registers Reece's claim to the $1EV.

Further, assume that this EVSPV executes a first bet in which Reece's claim has a payoff of $100 and a probability winning of 0.01. Further, assume Reece's claim wins this first bet.

Then, the EVSPV can query Reece and ask him if he indeed did buy babysitting services within two weeks of making his call to BestSitters. Reece can ignore the query, and the EVSPV can register this lack of response or, Reece can respond, “yes,” or “no,” and the EVSPV can register these responses as well.

If Reece responds, “yes,” then the EVSPV can execute a second bet. In this second bet, Reece's claim will have an EV=$100. Assume that the payoff is $500 and the probability of winning is 0.2. Finally, assume that Reece's claim wins this second bet, then the claim is provisionally worth $500, until an inspection takes place to see if Reece has met the conditions of the offer, that is, to see if Reece actually did buy babysitting services within two weeks of the call.

By querying recipients whose claims have won a first-stage bet, the EVSPS can gather and store data in a claims database and a user database (these databases can be a single database) so that a recipient's claiming history can be analyzed, particularly to find a pattern of cheating.

Accordingly, the invention provides a method for operating an EVSPV including the steps of:
querying a claimant upon a claim winning a first payment bet,
asking the claimant whether the claimant has met the conditions of the EV payment offer,
storing claimant's response or lack of response, in a claims database and/or a user database.

### Section B

### System Takes all the Payoff Risk In which EV is Deducted Per Bet from Payer

In this Section B, we assume that the EVSPV takes all the payoff risk in payment bets.

If the EVSPV takes the payoff risk, it will include a system bank account and means discussed above for establishing a payer bank account.

We assume that a payer, Paula, has established a payer bank account.

Then, each time a recipient submits a claim corresponding to Paula's payment offer, the EVSPV will deduct the amount of money specified by Paula's offer from Paula's bank account (for instance, a debit account) and transfer it into an EVSPV account. From that EVSPV account the system will pay payoffs to recipients.

But the process is more complicated than that; it is different from a conventional payment transfer system. The problem is that Paula is offering EV payment only to qualified claimants, but claimants who accept her offer will include qualified claimants and non-qualified claimants.

Assume that Paula offers $1 EV. Now, assume that 2,000 claimants accept her offer.

How much does Paula owe the EVSPV? If she pays $1 per claim it is not fair because she is only supposed to pay for qualified claimants. She does not know and the EVSPV does not know what percentage of claimants is qualified.

Paula and the EVSPV cannot know if a claimant is qualified until the uncertainty is resolved when, and if, a claimant wins his payment bet and submits his payoff claim data for inspection.

Therefore, to compensate Paula for having money deducted from her account for invalid claims (submitted by non-qualified claimants), the EVMSP and EVSPV can include the step of refunding a payoff, provisionally won by a claimant, to Paula when:
1) a claimant does not submit a payoff claim on a winning claim (usually meaning that the claimant does not think that he is a qualified claimant)
2) a claimant does submit a payoff claim, but the corresponding inspection then reveals that the claimant is not qualified—i.e., that payoff claim is invalid.

For example, assume BestSitter is offering $1 EV to referrers. Assume that Ray, the referrer, finds the offer, and selects the offer, thereby claiming the $1 EV. Then, the EVSPV would deduct $1 (definite dollar) from BestSitter's bank account and transfer it into an EVSPV account for paying off winning, valid claims. Assume that Ray's claim wins the payment bet with a payoff of $1,000. Then, assume that Ray does not submit a claim for the payoff. Then, the EVSPV would transfer the $1,000 to the BestSitter account. Likewise, if Ray does submit a claim for the payoff, but the claim is found invalid, then the EVSPV would transfer the $1,000 to the BestSitter account.

Accordingly, the invention provides a method for operating an EVSPV including the steps of:
register a claim by a Reece for a payment corresponding to Paula's EV payment offer,
deduct from Paula's account an amount of definite dollars equal to the EV of Paula's offer, and transfer that definite amount to an EVSPV account,
execute a payment bet to determine whether Reece's claim is a winner,
   if claim loses, set the value of the claim to zero,
   if the claim wins, ask Reece to submit a payoff claim,
      if Reece does not respond to the request, or if Reece responds that he cannot submit a payoff claim, transfer the payoff into Paula's account,
      if Reece submits a payoff claim, pass the claim to an inspector,
         if the inspector enters that the claim is invalid, then transfer the payoff into Paula's account,
         if the inspector enters that the claim is valid, then transfer (or authorize the transfer of) the payoff to Reece.

(To compensate an inspector and encourage users to only submit valid payoff claims, the system can include a process for receiving an inspection fee from a payoff claimant, and/or an inspection deposit, to be forfeited if the claim is invalid.)

The Problem with this Refund Method

The method of refunding payoffs to payers is fair in that, probabilistically speaking, on average, Paula gets back the money, deducted from her account, that pays for non-qualified claimants.

However, this “refunding” process is “lumpy” with infrequent, large payoff refunds that may not suit many payers, especially if the payoffs are too infrequent. For example, if Paula is offering $1 EV, and the payoff is $1,000, Paula may have over $1,000 deducted from her bank account to pay for non-qualified claimants, but she may not even receive a payoff refund. This situation will be unsatisfactory to many payers, especially payers that are very small businesses.

Below we give is one solution to this problem. In Sections C and D we describe two other solutions.

Using a Two-Bet (“Parlay”) Process

One solution is to split one payment bet into two, in which the payoff for the first bet is low enough so that a payer will receive refunds of a first payoff frequently enough to satisfy the payer (Paula). An EVMPV and EVSPV can use a two-bet process, as described in Section A, with two key differences.

One difference is that the system takes the payoff risk in both payment bets. The EV amount is deducted, in definite money, from Paula's account, per claim submission (offer acceptance).

A second difference is that the first bet payoff is refunded to the payer if the claimant (Reece) does not respond to a query after winning the first-stage bet, or if Reece gives a negative response, saying, “I did not meet the conditions of the payment offer.”

If Reece gives a positive response, a second bet is executed. If Reece's claim wins this second stage bet, then the claim is provisionally worth the second payoff.

Paying this payoff is handled the same way that a payoff claim is handled above, in Section B. That is, if an inspection reveals that Reece's claim is invalid, then the second stage payoff is refunded to the payer. If the inspection reveals that Reece's claim is valid, then the second stage payoff is paid to Reece.

Accordingly, the invention provides a method for operating an EVSPV including the steps of:
register a claim by Reece corresponding to an EV payment offer by Paula,
transfer from Paula's bank account to an EVSPV account an amount of money (x) equal to the EV offered in by Paula's offer,
execute a first bet in which Reece's payment claim has a first EV=x, and a First Payoff=y,
if Reece's claim loses this first bet, set Reece's claim value=zero, and do not continue making payment bets for the claim,
if Reece's claim wins this first bet, query Reece to see if he says he has met the conditions of the payment offer,
if Reece does not respond, or if Reece responds, “no,” then transfer (“refund”) the First Payoff, y, to Paula's account,
if Reece responds, “yes,” then execute a second bet in which Reece's claim has an EV=y, and a payoff=z,
   if Reece's claim loses this second bet, set Reece's claim value=zero, and do not continue making payment bets for the claim,
   if Reece's claim wins this second bet, assign Reece's claim provisional value=z
   ask Reece to submit payoff claim data,
      if Reece does not respond or if he says he cannot submit payoff claim data, then transfer (“refund”) the Second Payoff, z, to Paula's account,
      if Reece does submit payoff claim data, then send the data to an inspector to do an inspection,
         if the inspector finds the claim invalid, register that the claim is invalid and transfer (“refund”) the Second Payoff, z, to Paula's account,
         if the inspector finds the claim valid, pay the Second Payoff, z, to Reece's account (or authorize payment to Reece).

### Section C

### Two-Bet Process Where Payer and System Take Separate Payoff Risk In which the First Bet Payoff is Deducted from Payer

Section A described a two-bet process in which the payer takes the payoff risk in both bets. Section B described a two-bet process in which the system takes the payoff risk in both bets.

This Section C describes a two-bet process in which the payer takes the payoff risk in the first bet, and the system takes the payoff risk in the second bet.

This particular two-bet method can be useful because many payers cannot risk losing a large payoff, while virtually all payers can risk losing a payoff under a given threshold.

We note that the EVMPV can include steps for enabling a payer to set this threshold, or the threshold can be set by default. This threshold—a static amount or a multiple of a sale amount—can then be used as the payoff for the first bet in a two-bet process.

(As in Parts 1 and 2, we will often call a payer by the name, Paula, and an EV payment recipient/claimant by the name, Reece.)

Accordingly, the invention provides a method for operating an EVSPV including the steps of:

register a claim by Reece corresponding to an EV payment offer by Paula with EV=x,

execute a first bet in which Reece's claim has an EV=x, and a First Payoff=y,

if Reece's claim loses this first bet, set Reece's claim value=zero, and do not continue making payment bets for the claim,

if Reece's claim wins this first bet, then query Reece to see if he says he has met the conditions of the payment offer,

if Reece does not respond, or if Reece responds, “no,” set claim value=zero,

if Reece responds, “yes,” transfer y from Paula's account to an EVSPV account,
execute a second bet in which Reece's claim has EV=y, and Second Payoff=z,
if Reece's claim loses this second bet, the claim has zero value,
if Reece's claim wins this second bet, the claim has provisional value=z,
   ask Reece to submit payoff claim data,
   if Reece does not respond or if he says he cannot submit payoff claim data, then transfer (“refund”) the Second Payoff, z, from the EVSPV account to Paula's account,
   if Reece does submit payoff claim data, then send the data to an inspector to do an inspection,
      if the inspector finds the claim invalid, register that the claim is invalid, and transfer (“refund”) the Second Payoff, z, from the EVSPV account to Paula's account,
      if the inspector finds the claim valid, pay Reece the Second Payoff, z, from the EVSPV account.

Importantly, we note that the process above does not have to include steps for informing Reece that his claim has won the first bet; the two-bet aspect can be hidden from him. In this implementation, Reece would not be queried, of course, after the first bet. The First Payoff would be transferred from Paula's account to an EVSPV account, as above. But, in order for Reece to be queried, Reece's claim would have to win both bets. If Reece did not respond to this query, or he if he did respond, and his claim was found invalid, then the EVSPV would transfer the payoff to the Paula's account.

Illustration

As an illustration of the process above, assume that BestSitters sets up an account with the EVSPV and deposits $200.

Assume that BestSitters makes an offer to pay $1 EV to anyone who refers in a customer.

Assume that Ray accepts this offer, that is, submits a claim.

Then the EVSPV registers the claim and executes a first bet with EV=$1 and, let us assume, a First Payoff=$50.

Assume that Ray's claim wins the bet.

Then, the EVSPV deducts $50 from BestSitter's account and transfers it to an EVSPV account for paying payoffs.

Then, the EVSPV informs Ray that his claim has won the first bet and asks Ray whether he has met the conditions of the corresponding payment offer.

If Ray does not respond, or responds negatively, then the EVSPV refunds the $50 to the BestSitter account.

If Ray responds positively, then a second bet is executed, with an EV=$50 and a Second Payoff=$1,000, let us assume.

Then, if Ray wins this bet, the EVSPV asks him to provide proof that he referred in a customer.

If Ray does not respond, or does not provide adequate proof, the EVSPV transfers the $1,000 to the BestSitter account.

If Ray does respond and provides adequate proof of his referral, then the system authorizes the payment of (or simply pays) the $1,000 to Ray.

### Section D

### System Takes all the Payoff Risk and Uses a Discount Formula to Adjust for Invalid Claims

One way for the EVSPV to transfer payment from payers to recipients is to take all the risk in the payment bets, but to eliminate the refunding steps described in Section B, and instead use a discount formula that generates a discount factor of some sort.

In Section B, we described a method in which each time a recipient submits a claims corresponding to Paula's EV payment offer, the EVSPV will deduct definite money in the EV amount of the offer from Paula's bank account and transfer it into a EVSPV account. From that EVSPV account the system will pay valid, winning claims.

To repeat from Section B, the process is more complicated than that; it is different from a conventional payment transfer system. The problem is that Paula is offering EV payments only to qualified claimants, but people who accept her offer—submit claims, that is—will include qualified claimants and non-qualified claimants.

To repeat, Paula and the EVSPV cannot know if a claimant is qualified until the uncertainty is resolved by the claimant winning his payment bet and then passing/failing an inspection.

To compensate/adjust for non-qualified claimants, the EVSPV can include a process for applying a discount factor to the EV payment amount that Paula offers to claimants.

Then, each time a user submits a claims for an EV payment under Paula's offer, Paula would not owe EVSPV the full amount of the EV stated in the offer, but a discounted rate. For example, if the EV amount offered to qualified claimants is $1 and the discount factor is 20%, then EVSPV registers that Paula owes 20 definite cents per submitted claim.

The goal in a discount factor is to represent the percentage of claimants who are qualified claimants. To arrive at a fair discount factor, the general idea is to gather statistics on what percentage of claimants are qualified.

These statistics can be gathered from the responses to offers within EVSPV that are similar to Paula's offer. The EVSPV can feed this response data into the discount formula(s).

Other methods, such as survey methods can be used as well to yield discount factor data to be fed into discount formulas as well.

The discount formula(s) will use data on how many winning claims are qualified claims.

EVSPV may include one or more formulas to determine the discount factor to be applied to a payer's offer.

Accordingly, the invention provides a method of operating an EVSPV such that the EVSPV takes the payoff risk in EV payment bets and further includes:
a discount formula process (or processes) for arriving at a discount factor, to be applied to the EV amount of a payment offer.

(Alternatively, in certain implementations, the EVSPV will not include a discount formula, but will include means for enabling a system administrator to enter a discount factor.)

Further, when a user submits a claim for EV payment, the EVSPV will:

apply the appropriate discount factor to the EV payment amount,

deduct the resulting amount from the payer's bank account,

transfer the amount to a EVSPV account that is used to pay winning, qualified claimants.

Further, in the inspection process, when an the inspector approves a claim, the EVSPV will:
register that the claimant is owed the payoff from the EVSPV account that is used to pay winning claimants.

Note that while the amount being deducted from Paula's account is (EV)×(Discount Factor), or EV adjusted in some way by a discount formula, the EV of the payment claim remains the EV that was offered by Paula.

Thus, one weakness of the process above is that Paula and Reece can cheat by acting in cahoots. Because of the discount factor, the amount that Paula has to pay is not the full EV, while the system executes a bet where Reece does receive the full EV. The system makes up the difference. So, if Paula and Reece are cheating, they will receive, on average, (EV)−(EV×Discount Factor).

Using a Two-Bet Process where Payer and System Take Separate Payoff Risk in which the First Bet Payoff, Adjusted by a Discount Factor, is Deducted from the Payer's Account

The EVSPV can enable Paula to take the payoff risk in the first bet, but can apply a discount factor to this First Payoff. Thus, if the claimant wins this first bet, the system can deduct the First Payoff of this first bet, adjusted by the discount factor described above, from Paula's bank account and transfer this discounted First Payoff to the EVSPV account.

The EVSPV can then take the payoff risk in the second bet.

As with the process above, although a discount factor is applied to Paula's payoff obligation, the EV of the claim in this second bet equals the full First Payoff (the payoff of the first bet).

If the claim wins both bets, and if an inspection finds the claim valid, then the EVSPV transfers the second bet payoff to Reece.

### Section E

### Two-Bet Processes in Which EV Payment Equals a Percentage of a Sale

Context: Payment Offers Where the EV Payment Depends on an Uncertain Event, Especially a Purchase Amount (an Amount of Money in a Transaction)

In many kinds of EV payment offers, the amount of EV payment will depend on an uncertain event or series of events, such as the amount of a sale.

In particular, the amount of EV payment can be a percentage of the amount of money involved in an economic transaction, which we will call a sale amount, where sale is a generic term that encompasses any kind of sale, lease, loan, donation—and amount encompasses any amount of money transferred in an economic transaction.

For instance, BestSitters might offer Reece a payment for attention where the EV payment is 1% of how much Reece spends on babysitting services over the next month. In this case, the sale amount, and hence the specific EV payment amount, will not be known until the month has passed.

The EVMPV and EVSPV can include steps for handling payments that are contingent upon uncertain events, in particular, payments that are a percentage of sale amounts.

The steps involved are straightforward if one payment bet is used. In this case, the claimant will provide the sale amount information during the inspection process.

For instance, if BestSitters offers 1% of a sale amount to Reece, then a bet is executed. Let us assume that the probability of Reece's claim winning is 1/1000. Then, if Reece's claims wins, it will be worth 1%×1,000=10,000%=10 times the sale amount.

If Reece's claim wins, the EVSPV will ask Reece if he bought babysitting services over the past month, and if so, how much did he spend?

Let us assume Reece spent $80, then he will be owed $800.

So, to handle percentages, a payoff multiple is used in the EV payment bet.

Two-Bet Processes where Uncertainty is Resolved (Sale Amount Information is Provided) After the First Bet

If a two-bet process is used, then the first bet can use a payoff multiple.

Let us assume that the process of Section C is used in which Paula takes the payoff risk in the first bet and the EVSPV takes the payoff risk in the second bet.

The invention provides a method for operating an EVSPV including the steps described below.

If Reece's claim wins the first bet, the EVSPV can ask Reece if a sale was made, and if so, how much was spent. Reece can supply the answer, and the second bet terms can be based upon this information.

For example, let us assume the payoff multiple in the first bet is 10×, so that the probability of a claim winning is 1/10. Then, if Reece's claim wins this first bet, the claim is provisionally worth 10× the EV payment percentage offered.

Then, the EVSPV asks Reece if a sale was made, and if so, how much was spent. If Reece responds and supplies the sale amount, then this sale amount can be multiplied by the payoff multiple and multiplied by the EV payment percentage to arrive at a First Payoff that can be deducted from Paula's account.

For instance, assume the EV payment percentage offered is 1%. Assume the payoff multiple is 10×. And, assume that Reece says that a $600 sale was made.

Then, (1%)×10×$600=$60. This $60 is transferred from Paula's account to the EVSPV account for paying payoffs. And, this $60 is the EV of the second bet.

Two-Bet Process where the Uncertainty is Resolved (Sale Amount Information is Provided) After the Second Bet

It is also possible NOT to tell Reece that his claim has won the first bet, but simply to deduct some amount of definite money from Paula's account to be transferred into an EVSPV account, that is then used by pay out payoffs.

But, if the sale amount is not known, how much definite money is to be deducted from Paula's account?

One solution is for the EVSPV to check Paula's payment offer and assume the worst-case scenario, that Reece will report that largest sale possible under Paula's offer. The EVSPV, in other words, can deduct the maximum amount from Paula's account.

This method raises the problem of overpayment. To solve this problem, the refunding approach of the processes of Section B and Section C can be used.

When the uncertainty of the sale amount is resolved, the excess payment in definite dollars can be refunded, but refunded multiplied by the payoff multiple.

For example, assume that the payoff multiple of the first bet is 10×, and assume that the payment offer is 1% of a sale amount. Then, Reece is owed 10% of the sale amount.

Assume that the maximum sale amount under Paula's offer is $1,500, then Reece could potentially be owed $150. The EVSPV can deduct this amount from Paula's account.

Then, let us assume that the payoff multiple of the second bet is 10× as well. Then, if Reece's claim wins this bet, the claim is provisionally worth $1,500.

Now, let us assume that Reece submits a payoff claim stating that he spent $90.

Then, Reece would be owed $90 as the second payoff, NOT $1,500.

But, if the uncertainty had been resolved after the first bet, then Paula should only have paid $9, which is 10%×$90. Instead, Paula had $150 deducted from her account. So, she is owed $141. But, it is actually $141×10×−$1410.

Because of the complexity of this approach, it seems that, in practice, the uncertainty will be resolved after a claim wins a first bet, as described above.

### Section F

### Using Deposits to Reduce Inspection Costs

Inspecting a Fraction of the Payoff Claims

We expect that in most implementations of the invention, a claimant would have to put up a deposit or pay an inspection fee, both of which can ensure that his claim was valid.

The inspection fee would be paid whether the claim was valid or not. The deposit would be forfeit if the claim were invalid.

A twist on the idea of a deposit, to increase the efficiency of inspection, is to ask claimants to put up a large deposit (to post a bond, so to speak), and only inspect a fraction of the claims, with some pre-set selection method (e.g., random selection of claims).

The un-inspected claims would be presumed valid. The inspected claims, if invalid, would cause the deposit to be confiscated.

Accordingly, the invention provides a method of operating an EVSPV including the steps of:

executing an EV payment bet for a claim,

if the claim is loses, set the value=0,

if the claim wins, ask claimant to submit deposit of money to guarantee that the claim is valid,
if the claimant does not submit the deposit, set the value of the claim=zero,
if the claimant submits the deposit, store the deposit in an escrow-type account such that the deposit corresponds to the winning claim,
   subject the claim to a pseudo-random chance of being inspected according to a pre-set selection formula,
   if a winning claim has not been selected for inspection, assume that the claimant meets the conditions of the EV payment offer, pay the winning claimant the payoff, and release the deposit from the escrow account back to the claimant,
   if a winning claim has been selected for inspection, request payoff claim data (inspection data) from the claimant,
      if the claimant does not provide the payoff claim data, set the value of the claim=0, and confiscate the claimant's deposit,
      if the claimant provides payoff claim data, inform an inspector that the claim needs inspecting,
         if the inspector enters a decision that the claim is invalid, set the claim value=0, and confiscate the claimant's deposit,
         if the inspector enters a decision that the claim is valid, set the value of the claim=to the payoff of the payment bet, and authorize payment of the payoff to the claimant, and release the deposit from the escrow account back to the claimant.
            Centering the Invention Around the Use of Deposit (Around the Posting of Bonds)

The EVMPV and EVSPV use expected payments to reduce the number of inspections of claims.

It is possible to reduce inspections solely by using the method of having claimants post a bond to vouch for the honesty of their claims, and then auditing a percentage of those claimants.

We do not feel that this will be the dominant approach in the market because it requires people to put up large deposits upfront, but we note the possibility.

Instead, by reducing the average cost of inspections, the use of deposits may be an important addition to the payment processes of an EVMPV and EVSPV.

Further, and as a separate, useful process, the EVMPV and EVSPV can include steps that enable a claimant to choose whether to be paid:
1) an EV payment or
2) a definite payment contingent upon the claimant putting up a deposit and having the claim subject to inspection, according to a mostly/somewhat random selection.

This approach can work well when an EVSPV enables EV payments that range from small, say, 10 EV cents, to large, say 300 EV dollars. In some cases, claimants will prefer to receive definite payment rather than EV payment.

### Section G

### Miscellaneous Sub-Methods for Efficient and User-Friendly Transactions

Periodic EV Payments

In certain cases, an EV payment offer may stipulate that Reece will be paid periodically, such that he must meet the conditions of the payment offer during each, defined period. For example, Paula may offer to pay Reece a 5% EV referral fee for each month that a customer buys from Paula. Each month, then, Paula can check whether the customer has remained a customer. When the customer drops away, then Reece is no longer owed the EV referral fee.

The EVMPV and EVSPV can accommodate periodic payments by treating each period as a separate payment that requires a separate claim to be made. Or the EVMPV and EVSPV can enable a singe claim to trigger a series of payment bets, per period, that continue until a claimant requests that they stop. Or, the EVMPV and EVSPV can assume that the first period payment will determine the total payment. The possibilities are various and will depend upon the implementation and the payment offer.

Allowing Recipients to Assign EV Payments

One problem with the EVMPV and EVSPV is that many claimants do not like EV payment and would prefer definite payment. A way to solve this problem is for a claimant, before the result of his EV bet is revealed, to assign his EV bet payoff to a third party. The third party could pay the claimant a percentage of the EV for this assignment, through a private transaction, thus enabling the claimant to receive definite payment instead of EV payment. The third party would then collect the payoff, if any, upon a successful inspection.

Alternatively, the EVSPV can facilitate and record assignments. Further, the EVSPV could list EV payments to a recipient so that a recipient can assign a set of EV payments to a third party.

Accordingly, the invention can provide a method for operating an EVSPV including the steps of:
enabling a user to designate an assignee for one or more of the EV payments he claims,
enabling a user to state which EV's he is genuinely eligible for—i.e., claims in which he has met the conditions of the EV payment offers,
listing and tallying all the claims for EV payment a user has stated he is genuinely eligible to receive,
designating an assignee for the set of claims for EV payment a user has stated he is genuinely eligible to receive.
   Showing Net EV's

The owners of an EVSPV will usually need to be paid for its operation. As discussed, there are various ways of charging users for the services of the EVSPV. Some of these ways will involve transaction fees. These fees can be reflected in the EV's, odds, and payoffs of payment bets.

That is, the EVSPV can show net EV's to claimants/recipients that are different from the EV's advertised by payers in their payment offers.

Meta-Directory for Collecting and Sorting Similar EV Payment Offers

An EVSPV that transacts a particular kind of payment offer, such as a system for targeted discount offers, or referral offers, or payment-for-attention offers, will probably not be a monopoly service. There will be more than one EVSPV doing essentially the same thing.

Given this reality, it will be useful for payers and recipients of payment to collect all similar offers and put them in one sorted list. In other words, it will be useful to create a meta-directory of offers that are posted in EVSPV's.

This kind of meta-directory can be created through a central service that handles queries from payment claimants and then pulls matching offers from various EVSPV's and sorts those offers.

Or, the meta-directory can be created via software on a user's personal machine, such that the software takes a user query for a payment offer and then pulls matching offers from various EVSPV's, and sorts those offers, and presents a sorted list of those offers.

A meta-directory is obviously helpful to payment claimants. But it is also helpful to payers, especially a central service embodiment, because it can help collect global statistics that can be used to deter cheating and make payment offers more efficient.

Comment by James Stein on Reading this Specification

I was going to make the suggestion of something analogous to your discount factor. However, my suggestion would be to periodically refund to Paula the amount computed by using the discount factor, rather than require Paula to pay (EV)×(discount factor) initially.

I think the chances that Reece and Paula will be in cahoots is minimal; the only way that they can make money is to submit large numbers of claims, and I would assume the system can track this—or limit the number (or amount) of claims.

I claim:

1. a method for operating a computer database system for the purpose of enabling a seller to offer and transact discounts targeted to people according to criteria that the seller specifies, said method comprising:
(a) a seller entering into said database system a targeted discount offer including a product that a discount applies to, a discount amount and a set of targeting conditions for receiving that discount,
(b) specifying said discount amount as an expected value (EV), said EV to be paid via an EV payment bet including a Payoff,
(c) enabling a buyer to claim (accept) the targeted discount,
(d) executing an expected value payment bet in which the expected value is set at the discount amount,
(e) enabling a buyer to learn that she has provisionally won a payoff in the bet corresponding to the discount she claimed,
(f) enabling a buyer to claim that she is eligible for the payoff that corresponds to the discount,
(g) enabling inspection of the buyer to determine if she meets the membership conditions of the discount offer,
(h) enabling the winning, eligible buyer who has passed the inspection to be paid the payoff corresponding to the discount.
